(19) United States
(12) Patent Application Publication
(10) Pub. No.: US 2012/0001770 A1
(43) Pub. Date: Jan. 5, 2012

(54) SYSTEM AND METHOD OF PROVIDING TRAFFIC INFORMATION WITH TURNING INFORMATION AT INTERSECTIONS

(75) Inventors: Chi Nam Oh, Suwon (KR); Tae Soo Kim, Seoul (KR); Sung Hwan Park, Seoul (KR); Young Eon Ma, Ulsan (KR); Min Suk Kim, Yongin (KR)

(73) Assignee: HYUNDAI MOTOR COMPANY, Seoul (KR)

(21) Appl. No.: 13/169,431

(22) Filed: Jun. 27, 2011

(30) Foreign Application Priority Data
Jun. 30, 2010 (KR) 10-2010-0062807
May 13, 2011 (KR) 10-2011-0045033

(51) Int. Cl. G08G 1/09

(52) U.S. Cl. 340/905

(57) ABSTRACT

A technology is provided that improves reliability of traffic information guidance by reflecting traffic information for each turning direction. A system of providing traffic information with intersection turning information includes a vehicle information collection unit is configured to collect vehicle information and a control unit is configured to calculate general link speed, travelling speed for each turning direction and link speed for each turning direction at an intersection using the collected vehicle information.

### CROSS-REFERENCES TO RELATED APPLICATIONS

Priority is claimed to Korean patent application number 10-2010-0062807, filed on Jun. 30, 2010 and 10-2011-0045033, filed on May 13, 2011, the entire contents of which application is incorporated herein for all purposes by this reference.

### BACKGROUND OF THE INVENTION

1. Field of the Invention

The present invention relates to a system and method of providing traffic information along with intersection turning information, and more particularly, to a technology of providing traffic information along with intersection turning speed information.

2. Description of the Related Art

In recent years, traffic congestion has frequently occurred on roads or at intersections due to an increase in the amount of vehicles owned and operated by individuals throughout the world. For this reason, drivers receive traffic information from a traffic information center or the like, in order to better understand the road conditions, intersections or the like in which traffic congestion is occurring in advance and take detours if necessary.

However, in the related art, traffic information is provided based on only speed information for a straight road at intersections. No information accounts for the time required to turn left or right, the time required to pass through the intersections in an actual road environment, or the like.

Thus, in the related art, even in the case where traffic congestion does not occur on a straight road but does occur in regards to traffic turning left or right on a road by, e.g., construction or by illegally parked vehicles, since traffic information is provided on the basis of the straight road, there is no traffic information related to traffic congestion on a left-turning or right-turning road. Thus, the reliability of the traffic information is decreased.

In particular, when traffic information for intersections, access ramp of outer roads or highways, or the like, in which traffic jams frequently occur, is provided, it is difficult to understand the specific situation of the road if only traffic information related to the straight road is provided.

In the related art, since turning information for each of the roads such as intersections, or the like is not provided and only speed information for each link of the road in straight units is provided, drivers do not have accurate information of the time required in passing through the intersections. Thus, the reliability of the information is decreased.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

The present invention provides a technology for providing traffic information with high reliability, to which intersection turning information is reflected.

According to an aspect of the present invention, a system of providing traffic information with intersection turning information is provided. The system includes a vehicle information collection unit configured to collect vehicle information and a control unit configured to calculate general link speed, travelling speed in each turning direction at the intersection and link speed for each turning direction at an intersection using the collected vehicle information.

The control unit may be configured to calculate the travelling speed for each turning direction in the intersection by summing up link speed before entering the intersection and link speed after passing through the intersection calculated for each moving direction using position information of the vehicle.

The control unit may also be configured to calculate the link speed before entering the intersection using the position information. That is, the control unit may further calculate the link speed for each turning direction by calculating link speed before entering the intersection for vehicles which turn left, link speed before entering the intersection for vehicles which turn right and link speed before entering the intersection of vehicles which go straight.

The control unit may also be configured to assign a weight to a straight link, a left-turning link and a right-turning link, determine and assign any one of the straight link, the left-turning link and the right-turning link as a reference link and calculate speed for the reference link using the position information of the vehicle information and calculate a speed for the remaining links as a ratio of speed to the reference link.

The system may further include a traffic information guidance module configured to reflect the calculated general link speed, travelling speed for each turning direction and link speed for each turning direction to traffic information and provide the reflected traffic information to each vehicle.

The system may further include a road guidance module configured to reflect the calculated general link speed, travelling speed for each turning direction and link speed for each turning direction to path search information and provide the reflected path search information to each vehicle.

According to another aspect of the present invention, a method of providing traffic information with intersection turning information is provided. The method includes a process of wirelessly receiving vehicle information from one or vehicles, a process of calculating general link speed, travelling speed for each turning direction and link speed for each turning direction using received vehicle information and a process of reflecting the calculated general link speed, travelling speed for turning direction and link speed for turning direction to traffic information or path search information.

The calculating process may include calculating the travelling speed for each turning direction by summing up the link speed before entering an intersection and the link speed after passing through the intersection for each moving direction using position information of the vehicle information.

The calculating process may include calculating the link speed before entering the intersection using position information of the vehicle. The calculating process may further include calculating the link speed for each turning direction by calculating link speed before entering the intersection for vehicles which turn left, link speed before entering the intersection for vehicles which turn right and link speed before entering the intersection of vehicles which go straight.

The method may further include a process of wirelessly transmitting traffic information or path search information to which the calculated general link speed, travelling speed for each turning direction and link speed for each turning direction are reflected to each vehicle.

Advantageously, traffic information with turning information at intersections is provided by the present invention, the traffic information for each turning direction at an intersection or the like in which vehicles turn left or right is provided so that it effectuates an improved reliability in traffic information at intersections or the like.

In the system for providing traffic information with turning information at intersections according to the present invention, congested areas of intersections for a particular traveling direction are checked in detail to improve driver convenience.

The methods and systems of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a block diagram illustrating a configuration of an exemplary system of providing traffic information with turning information at intersections according to the present invention.

FIG. 2 is a view illustrating a configuration of an exemplary method of providing traffic information with turning information at intersections according to the present invention.

FIG. 3 is a view showing an exemplary method of calculating travelling speed for each turning direction at intersections of the present invention.

FIG. 4 is a view showing an exemplary method of calculating link speed for each turning direction at intersections of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Note that it is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

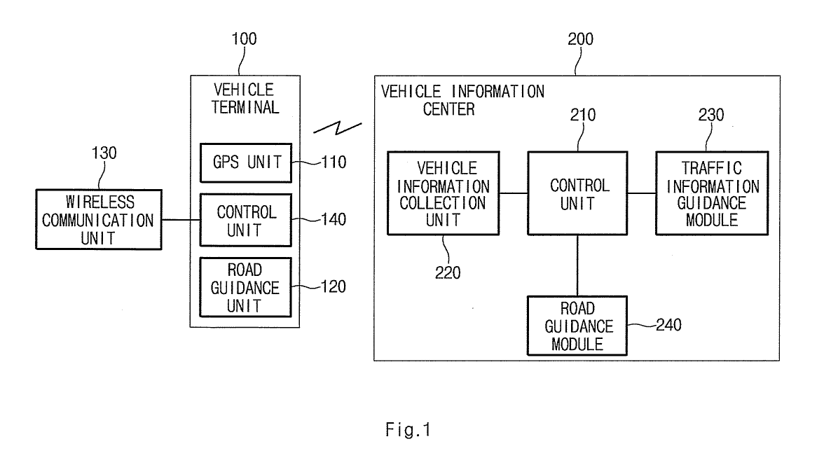

Hereinafter, a system and method of providing traffic information with intersection turning information according to the present invention will be described in detail with reference to the accompanying FIGS. 1 to 4.

FIG. 1 is a block diagram illustrating a configuration of a system of providing traffic information with intersection turning information according to an exemplary embodiment of the present invention. The system of providing traffic information along with intersection turning information according to an exemplary embodiment the present invention includes a vehicle terminal 100 and a vehicle information center 200.

The vehicle terminal 100 is installed inside a vehicle to perform wireless communication with the vehicle information center 200. The vehicle terminal 100 includes a telematics terminal, a navigation terminal, or audio/video (A/V) terminal and the like.

The vehicle terminal 100 may also include a global positioning system (GPS) unit 110, a road guidance unit 120, a wireless communication unit 130 and a control unit 140.

The GPS unit 110 collects position information about the vehicle at regular time intervals and the road guidance unit 120 reflects traffic information provided from the vehicle information center 200 to traffic information and performs road guidance on the basis of the reflected traffic information. The wireless communication unit 130 wirelessly communicates with the vehicle information center 200. The control unit 140 performs control of respective elements 110, 120 and 130 and calculates speed information of the vehicle using the collected position information. At this time, the present invention illustrates an example of calculating speed information of the vehicle using the position information, but the present invention may also calculate the speed of the vehicle through a separate speed meter (not shown) or transmission (not shown). When the vehicle terminal 100 provides the position information to the vehicle information center 200, the vehicle information center 200 may calculate the speed of the vehicle using the position information of the vehicle and use the calculated speed of the vehicle. Alternatively, the vehicle terminal 100 may directly provide its speed information to the vehicle information center 200.

The vehicle information center 200 collects vehicle information (speed information and position information of a vehicle and the like) through wireless communication and calculates general link speed, travelling speed for each turning direction and link speed for each turning direction at the intersection using the vehicle information for each vehicle.

The vehicle information center 200 includes a control unit 210, a vehicle information collection unit 220, a traffic information guidance module 230 and a road guidance module 240.

The control unit 210 calculates the general link speed, the travelling speed for each turning direction and the link speed for each turning direction in the intersection using the vehicle information. At this time, the general link speed in the intersection denotes link speed in the case where the speed of a left-turning or right-turning section is determined using a predetermined weighted value on the basis of speed of a straight section.

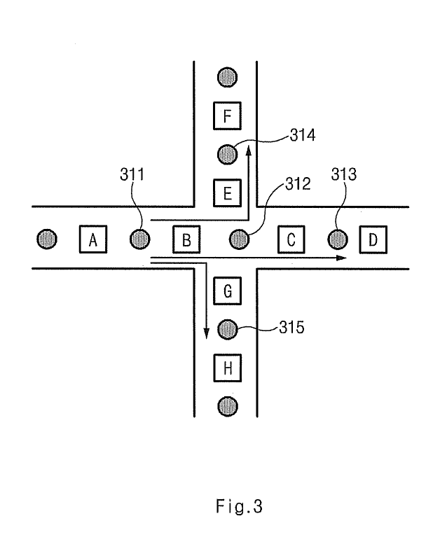

Referring to FIG. 3, in order to calculate the travelling speed for each turning direction, the control unit 210 sums up the average speed of a particular link (link B) before entering an intersection and the average speed of each of the other links (links E, C and G) after passing through the intersection for each moving direction using the vehicle information associated with a particular vehicle, thereby calculating the travelling speed for each turning direction (sections B-E, B-C and B-G). At this time, the travelling speed for each turning direction denotes an average speed of left-turning vehicles passing through adjacent two links, an average speed of straight vehicles passing through adjacent two links and average speed of right-turning vehicles passing through adjacent two links. It should be noted, that by links it is meant a particular section of road or thoroughfare which can be travelled. The average speed denotes an average value of minimum speed and maximum speed of the vehicles passing through each of the links. Right-turning travelling speed denotes an average value of minimum speed and maximum speed of vehicles passing through a section (from the link B to the link G), light-turning travelling speed denotes an average value of minimum speed and maximum speed of vehicles passing through a section (from the link B to the link C) and straight travelling speed denotes an average value of minimum speed and maximum speed of vehicles passing through a section (from the link B to the link C).

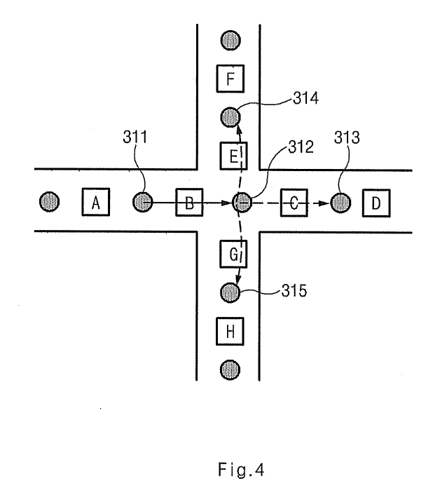

On the other hand, referring to FIG. 4, in order to calculate the link speed for each turning direction, the control unit 210 calculates the speed of the link (link B) located immediately before entering the intersection using the vehicle information. That is, the control unit 210 sums up the speed of a link (link B) for left-turning vehicles (those vehicles entering link E) before entering the intersection, the speed of a link (link B) for right-turning vehicles (those entering link G) before entering the intersection and the speed of a link (link B) for straight vehicles (those vehicles entering the link C), thereby calculating the link speed for each turning direction.

The link speed for each turning direction denotes an average speed when passing through one link. The link speed for each turning direction denotes an average speed when passing through a corresponding link for right-turning vehicles passing through the corresponding link, an average speed when passing through a corresponding link for left-turning vehicles passing through the corresponding link and an average speed when passing through a corresponding link for vehicles travelling straight thereby passing through the corresponding link. At this time, the average speed denotes an average value of minimum speed and maximum speed of speeds of a plurality of vehicles passing through the corresponding link. For example, a right-turning link speed is calculated as an average value of minimum speed and maximum speed at the time when right-turning vehicles pass through a corresponding link.

The vehicles information collection unit 220 collects vehicle information (position information, speed information and the like) from vehicles. The traffic information guidance module 230 reflects the general link speed, the link speed for each turning direction, the travelling speed for each turning direction at the intersection to the traffic information and provides the reflected traffic information to the vehicles. At this time, the traffic information guidance module 230 mainly provides the traffic information for each link and thus it is preferable to reflect the link speed for each turning direction to the traffic information and provide the reflected traffic information for each turning direction. For example, the traffic information guidance module 230 provides the link speed for each turning direction to the vehicle terminal 100. When guiding the traffic information for the intersection, the vehicle terminal 100 provides the traffic information for each turning direction at the intersection where the speed for each turning direction corresponds to the intersection displayed after an intersection map is displayed.

The road guidance module 240 performs a path search using the traffic information in which the general link speed, the link speed for each turning direction and the travelling speed for each turning direction are reflected and guides the searched path information to vehicles. At this time, the road guidance module 240 guides path data and thus it is preferable to reflect the travelling speed for each turning direction in order to display the travelling speed for a particular path. For example, when the road guidance module 240 transmits the path data including travelling speed information for each turning direction to the vehicle terminal 100, the vehicle terminal 100 displays an average travelling speed for each turning direction on an intersection map when guiding a path for passing through an intersection and allows a user to check the path's viability at a glance.

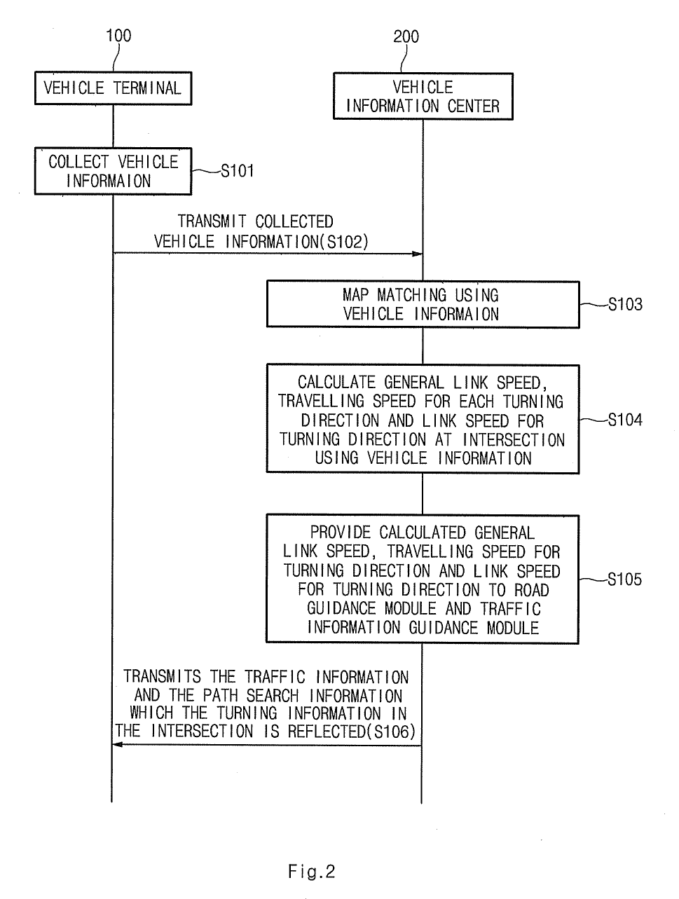

Hereinafter, a method of providing traffic information with intersection turning information according to an exemplary embodiment of the present invention will be described in detail with reference to FIG. 2.

First, the vehicle terminal 100 collects vehicle information (S101) and wirelessly transmits the collected vehicle information to the vehicle information center 200 (S102). At this time, the vehicle terminal 100 acquires current position information through a GPS at a regular time interval. When N pieces of position information are acquired or when a predetermined time has been elapsed, the vehicle terminal 100 transmits the collected position information to the vehicle information center 200.

The control unit 210 of the vehicle information center 200 performs map matching using the vehicle information (S103). At this time, the map matching displays a position of a vehicle on a map on the basis of the position information of the vehicle and removes any abnormal values.

Next, the control unit 210 of the vehicle information center 200 calculates a general link speed, traveling speed for each turning direction and link speed for each turning direction at an intersection using the vehicle information (S104). Hereinafter, a method of calculating the general link speed, the travelling speed for each turning direction, the link information for each turning direction at the intersection will be described in detail with reference to Tables 1 to 3 and FIGS. 3 and 4, respectively.

First, the method of calculating the general link speed at the intersection includes calculating left-turning travelling speed and right-turning travelling speed by multiplying a given fixed weight applied to a straight travelling speed after calculating the straight travelling speed.

TABLE 1

| | | | Avg. | Calculation method | |
|---|---|---|---|---|---|
| | From | | speed | of turning | |
| Classification | link | To ink | (Km/s) | travelling speed | weight |
| Straight link | B | C | 60 | 60 Km/s*1 | 1 |
| speed | | | | | |
| Left-turning | B | E | 30 | 60 Km/s*0.5 | 0.5 |
| link speed | | | | | |
| Right-turning | B | G | 42 | 60 Km/s*0.7 | 0.7 |
| link speed | | | | | |

That is, as illustrated in Table 1 and FIG. 3, it is assumed that the weight of the straight travelling speed, weight of left-turning travelling speed and weight of right-turning speed are, for example, set to “1”, “0.5” and “0.7”, respectively, when the straight travelling speed is 60 Km/s, the left-turning travelling speed becomes 30 Km/s and the right-turning speed becomes 42 Km/s. Here, average speed denotes an average value of a minimum speed and maximum speed measured from vehicles passing through a section of a corresponding intersection.

At this time, the link denotes a distance between nodes on a road. In FIG. 3, a section between a node 311 and a node 312 is referred to as a link B, a section between a node 313 and the node 312 is referred to as a link G, a section between a node 313 and the node 312 is referred to as a link C and a section between a node 314 and the node 312 is referred to as a link E.

Further, the link speed denotes speed when passing through a link. Straight link speed denotes speed before the link C after passing through the link B, left-turning link speed denotes speed before the link E from the link B and right-turning speed denotes speed before the link G from the link B.

Secondly, the method of calculating the travelling speed for each turning direction at the intersection includes calculating speed for each turning section using actual vehicle speed information for each section instead of the weight.

TABLE 2

| | | | Avg. | Min. | Max. | | ratio of |
|---|---|---|---|---|---|---|---|
| | | | speed | speed | speed | Refer- | speed to |
| | From | To | (Km/ | (Km/ | (Km/ | ence | refer- |
| Classification | link | link | s) | s) | s) | link | ence link |
| Left-turning | B | E | 60 | 38 | 59 | 0 | 1 |
| travelling speed | | | | | | | |
| Straight | B | C | 55 | 49 | 57 | x | 0.916 |
| travelling speed | | | | | | | |
| Right-turning | B | G | 58 | 63 | 63 | x | 0.966 |
| travelling speed | | | | | | | |

Here, the travelling speed denotes speed of a section in which adjacent two links are connected. As illustrated in Table 2, the left-turning travelling speed denotes speed of a section from the link B to the link E, the straight travelling speed denotes speed of a section from the link B to the link C and the right-turning travelling speed denotes speed of a section from the link B to the link G.

The vehicle information center 200 calculates a position for each vehicle and a speed for each moving section on the basis of the collected vehicle information and a ratio of speed to a reference link. For example, if it is assumed that the left-turning (from the link B to the link E) travelling speed is 60 Km/s and is set to the reference link, a ratio of speed to the reference link becomes about 0.916 (55 (Km/s)/60 (Km/s) in the straight section (from the link B to the link C) and a ratio of speed to the reference link becomes about 0.966 in the right-turning section (from the link B to the link G).

At this time, the turning direction includes multiple directions such as left-turning and right-turning which occurs at a three-way intersection, four-way intersections or five-way intersections. Further, minimum speed and maximum speed of vehicles passing through a corresponding section at the intersection are measured for each of travelling speed and average speed is calculated on the basis of the measured minimum speed and maximum speed.

Thirdly, the method of calculating the link speed for each turning at the intersection includes calculating speed for one link. That is, the method includes calculating speed by classifying a pass expectation direction.

TABLE 3

| | | Pass | | | Max. | Number |
|---|---|---|---|---|---|---|
| | | expectation | Speed | Min. speed | speed | of |
| Classification | Link | link | (Km/s) | (Km/s) | (Km/s) | vehicles |
| Left-turning | B | E | 62 | 52 | 70 | 3 |
| link speed | | | | | | |
| Straight link | B | C | 55 | 50 | 60 | 1 |
| speed | | | | | | |
| Right-turning | B | G | 52 | 48 | 56 | 2 |
| speed | | | | | | |
| Right-turning | E | B | 36 | 32 | 40 | 2 |
| link speed | | | | | | |
| Left-turning | E | C | 43 Km/ | 40 Km/ | 47 Km/ | 4 |
| link speed | | | s | s | s | |

As illustrated Table 3 and FIG. 4, as the link speed for each turning, speed for one link, that is, link speed for each turning direction is calculated.

For example, minimum speed and maximum speed are measured when turning left in the link B are measured and an average value of the measured minimum speed and maximum speed is calculated, thereby calculating average speed when turning left in the link B. When the link speed for each turning direction is calculated using such a method, an average speed in tuning left in the link B is for example, 62 Km/s, an average speed in going straight in the link B is for example, 55 Km/s and an average speed in turning right in the link B is for example, 52 Km/s.

When the general link speed, the traveling speed for each turning direction and the link speed for each turning direction at the intersection are calculated, the control unit 210 provides speed information to the road guidance module 240 and the traffic information guidance module 230 (S105), thereby allowing the calculated speed information to be reflected to traffic information and path search information provided to each vehicle.

The vehicle information center 200 wirelessly transmits the traffic information and the path search information to which the turning information in the intersection is reflected as described above to each vehicles (S106).

Although an example of the four-way intersection is illustrated in FIGS. 3 and 4, the present invention can be applied to traffic information at various intersections such as a three-way intersection or the four-way intersection. Further, the present invention can be applied to traffic information at a access ramp of a highway or outer road in addition to at the intersection.

As described above, the present invention can provide the travelling speed or link speed for each turning direction to provide for more accurate traffic information to which traffic turning information is reflected. In addition, the present invention can provide the general link speed together with the travelling speed or link speed for each turning direction to provide the traffic information for various intersections. The present invention can calculate the traffic information using various pieces of collected vehicle information so that an error range can be minimized to generate traffic information data with high quality.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents

What is claimed is:

1. A system of providing traffic information with intersection turning information, the system comprising:
a vehicle information collection unit configured to collect vehicle information; and
a control unit configured to calculate general link speed, travelling speed for each turning direction in an intersection and link speed for each turning direction at the intersection using the collected vehicle information.

2. The system according to claim 1, wherein the control unit calculates the travelling speed for each turning direction by summing up link speed before entering the intersection and link speed after passing through the intersection calculated for each moving direction using position information of the vehicle information.

3. The system according to claim 1, wherein the control unit calculates the link speed before entering the intersection using the position information of the vehicle information,
wherein the control unit calculates the link speed for each turning direction by calculating link speed before entering the intersection for vehicles which turn left, link speed before entering the intersection for vehicles which turn right and link speed before entering the intersection of vehicles which go straight.

4. The system according to claim 2, wherein the control unit calculates the link speed before entering the intersection using the position information of the vehicle information,
wherein the control unit calculates the link speed for each turning direction by calculating link speed before entering the intersection for vehicles which turn left, link speed before entering the intersection for vehicles which turn right and link speed before entering the intersection of vehicles which go straight.

5. The system according to claim 1, wherein the control unit assigns weight to a straight link, a left-turning link and a right-turning link, determines any one of the straight link, the left-turning link and the right-turning link as a reference link and calculates speed for the reference link using position information of the vehicle information and calculates speed for the remaining links as a ratio of speed to the reference link.

6. The system according to claim 2, wherein the control unit assigns a fixed weight to each of a straight link, a left-turning link and a right-turning link, determines any one of the straight link, the left-turning link and the right-turning link as a reference link and calculates speed for the reference link using position information of the vehicle information and calculates speed for the remaining links as a ratio of speed to the reference link.

7. The system according to claim 1, further comprising a traffic information guidance module configured to reflect the calculated general link speed, travelling speed for each turning direction and link speed for each turning direction to traffic information and provide the reflected traffic information to each vehicle.

8. The system according to claim 2, further comprising a traffic information guidance module configured to reflect the calculated general link speed, travelling speed for each turning direction and link speed for each turning direction to traffic information and provide the reflected traffic information to each vehicle.

9. The system according to claim 1, further comprising a road guidance module configured to reflect the calculated general link speed, travelling speed for each turning direction and link speed for each turning direction to path search information and provide the reflected path search information to each vehicle.

10. The system according to claim 2, further comprising a road guidance module configured to reflect the calculated general link speed, travelling speed for each turning direction and link speed for each turning direction to path search information and provide the reflected path search information to each vehicle.

11. A method of providing traffic information with intersection turning information, the method comprising:
wirelessly receiving vehicle information from vehicles;
calculating general link speed, travelling speed for each turning direction and link speed for each turning direction using the received vehicle information; and
reflecting the calculated general link speed, travelling speed for turning direction and link speed for turning direction to traffic information or path search information.

12. The method according to claim 11, wherein the calculating process includes calculating the travelling speed for each turning direction by summing up link speed before entering an intersection and link speed after passing through the intersection for each moving direction using position information of the vehicle information.

13. The method according to claim 11, wherein the calculating process includes calculating the link speed before entering the intersection using the position information of the vehicle information,
wherein the calculating process includes calculating the link speed for each turning direction by calculating link speed before entering the intersection for vehicles which turn left, link speed before entering the intersection for vehicles which turn right and link speed before entering the intersection of vehicles which go straight.

14. The method according to claim 12, wherein the calculating includes calculating the link speed before entering the intersection using the position information of the vehicle information,
wherein the calculating includes calculating the link speed for each turning direction by calculating link speed before entering the intersection for vehicles which turn left, link speed before entering the intersection for vehicles which turn right and link speed before entering the intersection of vehicles which go straight.

15. The method according to claim 11, further comprising wirelessly transmitting traffic information or path search information to which the calculated general link speed, travelling speed for each turning direction and link speed for each turning direction are reflected to each vehicle.

16. The method according to claim 12, further comprising wirelessly transmitting traffic information or path search information to which the calculated general link speed, travelling speed for each turning direction and link speed for each turning direction are reflected to each vehicle.
